(19) United States
(12) Patent Application Publication
(10) Pub. No.: US 2025/0216648 A1
(43) Pub. Date: Jul. 3, 2025

(54) APPARATUS AND METHOD FOR FOCUSING SUNLIGHT AT HIGH POWER AND CONCENTRATION

(71) Applicant: Arizona Board of Regents on Behalf of the University of Arizona, Tucson, AZ (US)

(72) Inventors: James Roger P. ANGEL, Tucson, AZ (US); Nicholas DIDATO, Tucson, AZ (US); Matthew L. RADEMACHER, Tucson, AZ (US)

(73) Assignee: Arizona Board of Regents on Behalf of the University of Arizona, Tucson, AZ (US)

(21) Appl. No.: 18/847,824

(22) PCT Filed: Mar. 20, 2023
(86) PCT No.: PCT/US2023/015674

§ 371 Date: Sep. 17, 2024

Related U.S. Application Data
(60) Provisional application No. 63/321,527, filed on Mar. 18, 2022.

(51) Int. Cl. G02B 7/183; F24S 20/20; F24S 23/74; F24S 30/45; G02B 5/10; G02B 19/00; G02B 26/08

(52) U.S. Cl. CPC G02B 7/183; F24S 20/20; F24S 23/745; F24S 30/45; G02B 5/10; G02B 19/0019; G02B 19/0042; G02B 26/0816

(57) ABSTRACT

A heliostat includes a reflector that has at least one segment arranged in a segment assembly and that defines a reflecting surface; a rigid spaceframe structure that includes a plurality of struts joined at nodes, the plurality of struts supporting the segment assembly so as to hold the reflecting surface in a concave toroidal shape; a dual-axis mount constructed and arranged to support and orient the rigid spaceframe structure and the segment assembly so as to reflect sunlight incident on the reflecting surface toward a distant receiving surface, the dual-axis mount including at least two drives; at least one mechanical linkage coupled to at least one drive of the dual-axis mount and configured to change a relative position of at least two nodes of the rigid spaceframe structure in synchronization with motion of the at least one drive, and thereby changing a shape of the rigid spaceframe structure and the reflector.

### CROSS-REFERENCE OF RELATED APPLICATION

This application claims priority to U.S. Provisional Application No. 63/321,527 filed Mar. 18, 2022; the entire content of which is hereby incorporated by reference.

### GOVERNMENT SPONSORED RESEARCH AND DEVELOPMENT

This invention was made with government support under Grant No. DE-EE0010246 awarded by Department of Energy. The government has certain rights in the invention.

### BACKGROUND

### 1. Technical Field

Currently claimed embodiments of this invention relate to systems and methods for focusing sunlight at high power and high concentration, and more particularly for commercial use of solar energy as an economically viable form of renewable energy.

### 2. Discussion of Related Art

High concentration of sunlight at a receiver is advantageous because it provides for high temperature at the receiver. This in turn allows for both higher efficiency conversion of solar thermal energy into electricity, and for a broad range of solar industrial process heat (SIPH).

Solar thermal production of hydrogen from water—for example, by the redox reaction of cerium oxide at 1,500 C.—requires concentration of ˜3,500× to avoid significant energy loss by thermal radiation escaping back out of the reactor window (Brendelberger 2021).

Very high solar concentration, for example >10,000 suns, may be obtained using a paraboloidal reflector which is turned to point at the sun through the day, but the cost per unit area for large steerable paraboloids is too high to make them commercially viable. Lower cost may be achieved using a large, fixed paraboloid together with a field of flat heliostats to direct sunlight into the reflector along the paraboloid axis. A heliostat is a device generally in a fixed location, with a mirrored surface to reflect solar energy toward a fixed target. Heliostats typically have one or more back-silvered glass mirrors attached to a rigid steel frame. A heliostat includes a tracking mechanism which turns the reflecting surface to maintain the reflected sunlight on the target as the sun moves through the sky. The largest high power system with very high concentration was built as shown schematically in FIG. 1 (Trombe and Le Phat Vinh, 1977, in a paper entitled Thousand kW solar furnace, built by the National Center of Scientific Research, in Odeillo (France). A sloping field of 63 flat heliostats, each with area 45 m², relay parallel beams of sunlight into a 40 m high×50 m wide paraboloid of area >2,000 m² and 18 m focal length. The system realizes 1 MW of solar thermal power at a concentration of 5000 suns. However, while useful for research, this system remains too costly to build and maintain for commercial renewable energy. The paraboloid is made up from 9,500 glass panes, individually bent and mounted to form the reflecting surface, and the heliostats use another 11,000 flat glass mirrors on steerable mounts. The total mirror area is more than twice the collecting area.

The mirror area per unit area of collection is reduced in the system described in U.S. Pat. No. 4,000,733 to Pauly, 1977, Solar Furnace, in which sunlight concentrated by multiple flat heliostats onto a paraboloidal dish is further concentrated by additional mirrors and lenses, but the description gives no quantitative specifics.

At lower concentration, <1,000 suns, very large heliostat installations have been used to collect very high solar power for thermal generation of electric power (CSP). Typically, in such systems, the receiver is sized to subtend an angle of ¾ to 1 degree, as seen from a heliostat, and the heliostats, which are essentially flat, are sized to be smaller than the size of the sunlight illumination formed at the receiver. Heliostats with size approximately ⅓ the solar disc size are typical in the largest CSP installations. A disadvantage of using such small, flat heliostats is that to obtain high sunlight concentration, a very large number must be used; for example, some 50,000 heliostats are needed around a tower-mounted cylindrical receiver to obtain a ratio of receiver-to-mirror area ˜800, in the best cases. The resulting complexity is high, and concentration at the target allowing for cosine and other losses is low at around 500×.

Very high concentrations are in principle achievable with the high powers available at the focus of a heliostat field, provided each individual heliostat realizes the highest concentration set by thermodynamics of sunlight on a distant target—this is achieved if the heliostat reflector is shaped to form a disc image of the sun at the receiver, of angular diameter equal to 0.55° (9.2 milliradians). The heliostat reflector shape needed to form an image of the sun depends on the angle at which sunlight strikes the reflector, and this angle changes as the position of the sun in the sky moves throughout the day. In general, the different shapes are toroids, i.e. surfaces with concave curvature that varies according to angle around the mirror.

U.S. Pat. No. 4,459,972 to Moore discloses such a concave focusing reflector formed as a section of a toroid of fixed shape, chosen to produce a disc image of the sun at midday. To minimize the image degradation at other times of day, a heliostat reflector with fixed toroidal curvature may be oriented by a mount constructed with a first rotation axis along the line to the target, as shown in FIG. 2 (from K. Chong, “Optical analysis for simplified astigmatic correction of non-imaging focusing heliostat,” Sol. Energy 84 (8), 1356-1365 (2010)). The shape error is limited to the amount of curvature in the two toroid axes, because with this dual axis mount geometry the angular orientation of the toroid is held correctly aligned. This type of mount is called variously target aligned or target-axis.

To form a disc image of the sun throughout the day, whatever the angle of incidence of the sun on the reflector, requires not only that the toroid axis have the correct rotation angle, but also that the toroidal radii of curvature be set according to the changing angle of incidence (AOI). These changes are given by the Coddington equations and are shown in FIG. 3. The changes get to be large for larger angles of incidence, thus at 60 degrees AOI the sagittal radius is doubled, and the tangential radius is halved.

Heliostats built for a target-axis mount that also have the capability to change the two toroidal radii of curvature (and thus the potential to extend solar disc imaging over more of the day) have been described in three publications. In U.S. 2015 0323772A1 Mixed Heliostat Field, L. Gallar describes a reflecting surface assembled from many small reflecting segments which are oriented by a system of cams and two drive motors. A similar mechanism is described by Chong, referenced above. A different, passive approach to changing the tangential and sagittal toroid curvature of a heliostat on a target axis mount is described by Lehmann and Allenspach in PCT/AU2012/000382, Toroidal heliostat, where the support of the reflecting surface is configured to bend by passive means, including changing orientation to gravity.

In practice, neither of the above two approaches have been adopted for commercial use because of complexity and cost. A further difficulty of both is that the provisions for curvature adjustment reduce stiffness and strength, whereas commercial heliostats must maintain accurate pointing in wind and survive wind gusts of up to 90 mph.

In a third prior art invention PCT/US2020/053130, 2021, Actively Focused Lightweight Heliostat, the entire content of which is incorporated herein by reference, Angel et al describe a heliostat on an alt-azimuth mount whose reflecting surface is 1) mounted on a stiff spaceframe structure, 2) has a toroidal shape which is made adjustable by the inclusion of many back struts that form part of the spaceframe structure, and 3) is positioned by three or more electrically driven actuators driven under computer control. A prototype using a hexagonal mirror on an alt-az mount and three independent actuators was demonstrated to give sharp disc images of the sun with 1/10 the area of the reflector over a wide range of angles of incidence. But while this invention combines stiffness and accurate changes in toroidal shape, it is complex and may not be cost effective. It is also not equipped to track the sun, as needed to exploit sharp solar disc images for the highest time-averaged concentration at the receiver.

In order to realize the full potential for very high concentration from a field of heliostats focusing disc images, the heliostat must be equipped for orientation to very high accuracy. If, for example, the overall error of the reflector surface relative to the ideal toroid for disc imaging is 1 mrad rms, then the reflector should be oriented to better than 1 mrad rms, averaged over time, to avoid significant additional blurring of the time-averaged concentration.

In prior art, systems have been described targeting such high accuracy tracking by using fisheye cameras in closed loop control. In such systems, the camera is fixed to the reflector with known relative orientation, and one or more images are taken that include the sun and another separate object. Given accurate knowledge of the position of both these sources, the camera orientation (and hence that of the reflector) may be accurately computed. Systems have been described that use solar-illuminated objects as the second source. In one previous implementation, U.S. Pat. No. 8,153,945 B2, Hickerson and Reznik, 2012, the second source is the solar illuminated receiver, but its position is not accurately known: its optical center of gravity depends on the orientations of all the heliostats providing illumination. If some are off in position, the others will follow like sheep. In another implementation, Reduced to minimum cost: Lay-down heliostat with monolithic mirror-panel and closed loop control, 2018, Pfahl et al, sunlight reflected from different parts of the tower supporting the receiver is used as a second source; however, reliable orientation data is difficult to obtain, because the tower image is much fainter and much more complex than the solar disc image, and therefore it requires separate much longer exposure.

The challenges to achieving high concentration and high power, along with the long-felt needs to lower the cost of increased sunlight concentration and reduce losses at the receiver obtaining energy from many heliostats, continue to leave room for improvement over the prior art.

### SUMMARY

A heliostat according to some embodiments of the current invention includes a reflector that has at least one segment arranged in a segment assembly and that defines a reflecting surface; a rigid spaceframe structure that includes a plurality of struts joined at nodes, the plurality of struts supporting the segment assembly so as to hold the reflecting surface in a concave toroidal shape; a dual-axis mount constructed and arranged to support and orient the rigid spaceframe structure and the segment assembly so as to reflect sunlight incident on the reflecting surface toward a distant receiving surface, the dual-axis mount including at least two drives; at least one mechanical linkage coupled to at least one drive of the dual-axis mount and configured to change a relative position of at least two nodes of the rigid spaceframe structure in synchronization with motion of the at least one drive, and thereby changing a shape of the rigid spaceframe structure and the reflector. Wherein the change of the relative position of the at least two nodes alters the shape of the reflector in such a way as to change a toroidal reflector shape so as to form and maintain a focused disc image of the sun on the distant receiver as the dual-axis mount is turned to follow the sun's motion throughout the day.

A system for tracking a plurality of heliostats according to some embodiments of the current invention includes a plurality of heliostats arranged in a heliostat field; a plurality of wide-field digital fisheye cameras, one attached rigidly to the reflector or support frame of each of the heliostats; one or more light sources located on towers, within or adjacent to the heliostat field, with at least one of the light sources arranged to be visible to each of the plurality of wide-field digital fisheye cameras; an image processor configured to communicate with each camera of the plurality of wide-field digital fisheye cameras to record image data for a continuous sequence of images, each image of the sequence of images capturing the sun and at least one of the one or more light sources; and a computer configured to receive the image data from the image processor. The computer is configured to process the image data, in conjunction with the known position of the light source and position of the sun at each instant of imaging, to compute an orientation of each heliostat reflector of the plurality of heliostats, and to control and correct future tracking motions of each heliostat so as to direct reflected sunlight accurately to a receiver of the plurality of heliostats.

A system for focusing sunlight at high power and concentration according to some embodiments of the current invention includes a tower; one or a plurality of compound parabolic concentrators (CPCs) mounted atop the tower; a plurality of heliostats arranged in an array on the ground, each heliostat of the plurality of heliostats includes an active reflector, each active reflector defining a reflector shape that is changed while in operation so that reflected sunlight is focused to form and maintain a disc image of the sun centered on one of the CPCs over a period of time while in operation. The plurality of heliostats are arranged within one or more ellipses formed by an intersection of an acceptance cone angle of each CPC and the ground, in a close packed configuration within each ellipse, out to distances not larger than that which yields a disc image of the sun equal in size to the CPC entrance diameter. The sunlight from the plurality of heliostats is efficiently coupled into the CPC, which outputs high power solar energy at high concentration, up to 4,000 suns.

An apparatus for focusing sunlight at high power and concentration according to some embodiments of the current invention includes a tower; a cylindrical receiver mounted on the tower; and a plurality of heliostats, each heliostat of the plurality of heliostats including an active reflector, each active reflector defining a reflector shape that is changeable while in operation so that reflected sunlight is focused to form and maintain a disc image of the sun over a period of time while in operation. The plurality of heliostats are arranged in a 360-degree array surrounding the tower and oriented to reflect and focus the solar disc images onto the cylindrical receiver. The receiver presents an area to any one of the plurality of heliostats of no more than twice that of an accurately imaged solar disc from the distance of the most distant heliostat. The solar concentration averaging over the full cylinder surface of >1000 suns is achieved for solar elevations >20 degrees.

### BRIEF DESCRIPTION OF THE DRAWINGS

FIG. 1 is a schematic illustration of a solar furnace powered by flat heliostats;

FIG. 2 is a schematic illustration of a target-aligned heliostat geometry;

FIG. 3 shows toroidal curvature amplitudes of a focusing reflector as a function of angle of incidence to facilitate explanation of some concepts of the current invention;

FIGS. 4A-4C show contour maps of toroidal surfaces for angle of incidence of 0, 60 and 70 degrees;

FIG. 5 is a schematic illustration of a reflector with adjustable shape spaceframe support according to an embodiment of the current invention;

FIG. 6 is a schematic illustration of a 1^{st} embodiment of a heliostat with shape adjustable reflector on a target axis mount according to an embodiment of the current invention;

FIG. 7 shows detail of the mount of FIG. 6 showing drives and a mechanical linkage;

FIG. 8 shows detail showing cam actions as cross-axis angle is increased, from left to right according to an embodiment of the current invention;

FIG. 9 shows detail of a cross axis bearing with mechanical coupling according to an embodiment of the current invention;

FIG. 10 provides a rear view of a 2^{nd} embodiment of a heliostat with shape adjustable reflector;

FIG. 11 is a plan view of rectangular reflector of the mount of FIG. 10;

FIG. 12 is a central plan view detail of the plan view of FIG. 11;

FIG. 13 is a side view of the rack and pinion cam system of FIG. 10;

FIG. 14 provides an end view of the rack and pinion cam system of the mount of FIG. 10;

FIG. 15 is a three-dimensional view of the rack and pinion mechanism of FIG. 13;

FIG. 16 shows an embodiment of a pattern of supports for a rectangular glass sheet according to an embodiment of the current invention;

FIG. 17 shows ideal toroids (left), and modeled toroids (right), 130 m focal length and angles of incidence of 0, 60 and 70 degrees;

FIG. 18 shows ideal toroids (left), and modeled toroids (right), 64 m focal length and angles of incidence of 0, 60 and 70 degrees;

FIG. 19 shows an image of solar disc calculated for 130 m focal length and angles of incidence of 0, 60 and 70 degrees of FIG. 17;

FIG. 20 shows schematically a light source with multiple LEDs according to an embodiment of the current invention;

FIG. 21 shows a camera with fisheye lens and filter according to an embodiment of the current invention;

FIG. 22 is a schematic diagram of closed loop control using fisheye camera according to an embodiment of the current invention;

FIG. 23 shows a compound parabolic concentrator according to an embodiment of the current invention;

FIG. 24 is a plan view of an elliptical field of 88 heliostats according to an embodiment of the current invention;

FIGS. 25A-25D show views of the field of FIG. 24 with the heliostats oriented to focus light from the sun at elevation 40° and at azimuth 90° and 0°. 24a and 24c show the views as seen from the sun, 24b and 24d show the views as seen from the receiver.

FIG. 26 is a plan view of field powering 5 CPCs according to an embodiment of the current invention;

FIG. 27 is a plan view of circular field of heliostats according to an embodiment of the current invention;

FIG. 28A (a) is a view of a 45° section of FIG. 26 as seen from the sun at elevation 40° and at azimuth 90° FIG. 28B (b) is a view from the receiver for the same field section;

FIG. 29 is a schematic illustration of a cylindrical receiver with a flat secondary reflector to double the flux concentration.

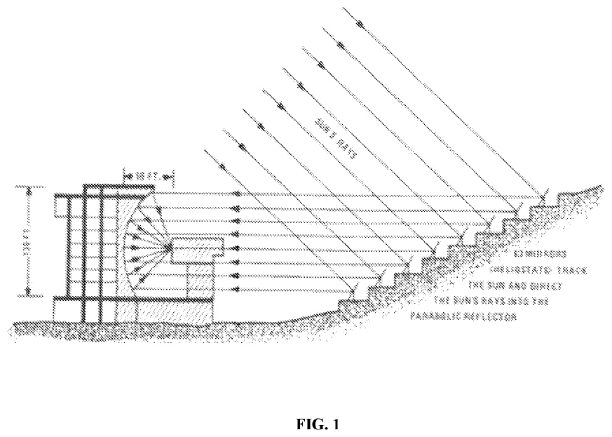

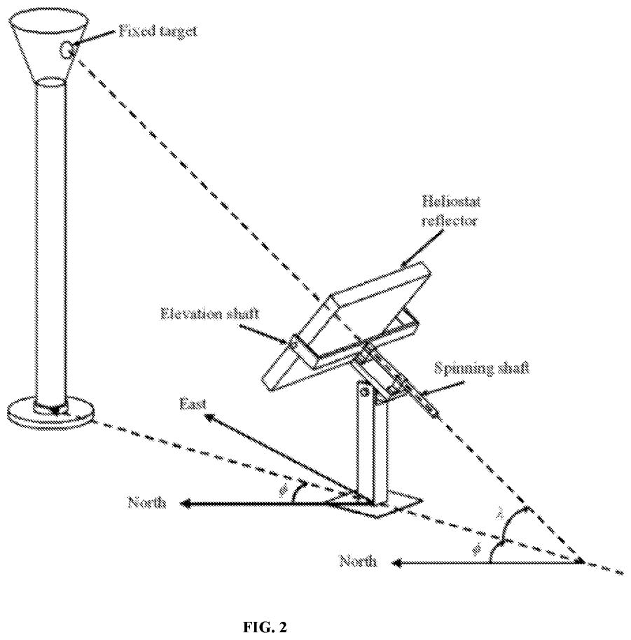

### DETAILED DESCRIPTION

Some embodiments of the current invention are discussed in detail below. In describing embodiments, specific terminology is employed for the sake of clarity. However, the invention is not intended to be limited to the specific terminology so selected. A person skilled in the relevant art will recognize that other equivalent components can be employed, and other methods developed, without departing from the broad concepts of the present invention. All references cited anywhere in this specification are incorporated by reference as if each had been individually incorporated.

Accordingly, some embodiments of this invention relate to apparatuses and methods for focusing sunlight at high power and high concentration, for example, as high as 4,000 suns. The apparatus includes heliostats with active adjustment of surface shape and provision for accurate sun-tracking, and optical configurations to receive and further concentrate sunlight onto a receiver. The application can be for commercial use of solar energy as an economically viable form of renewable energy.

Accordingly, an embodiment of the current invention is directed to systems. apparatuses and methods for focusing sunlight at high power and high concentration, for example, >1,000 suns. Such an apparatus includes heliostats with unique active adjustment of surface shape, provision for high accuracy sun-tracking, and optical configurations to receive and further concentrate sunlight onto a receiver. Applications of some embodiments of the current invention can include commercial use of solar thermal energy as an economically viable form of renewable energy.

A heliostat design according to some embodiments of the current invention is one in which the concave reflector shape is continuously and automatically altered through the day. Some embodiments of the current invention include methods of using configurations of fields of such heliostats so as to deliver sunlight at high concentration and high power to a receiver. The individual heliostats each maintain a sharply focused disc image of the sun at the receiver. The receiver reflector shape is a toroid, with curvatures and orientation adapted according to the changing angle of incidence of the sun. In some embodiments of this invention, the shape changes are accomplished by a simple mechanical coupling to the tracking motion of the mount that changes the strut lengths of a stiff supporting mechanical truss or spaceframe, according to heliostat orientation.

The heliostat reflectors of this embodiment are oriented by and are mechanically coupled to a target-oriented dual-axis mount. The mount turns the heliostat about a first (target) axis, which is aimed at a distant surface that receives the reflected sunlight, and about a second (cross) axis perpendicular to both the first axis and to the reflector surface. The rotation angles of both axes are adjusted to orient the reflector so as to reflect sunlight toward the receiving surface; i.e., along the direction of the first axis. The rotation motion of the second axis then tracks the angle of incidence (AOI) of sunlight on the reflector, and is mechanically linked to change the toroidal shape of a rectangular reflector as needed to focus a sharp disc image of the sun. Struts extending out from a back central node of the speceframe are moved to raise or lower the corners of the reflector as required. To obtain high concentration by a field of many such heliostats, all directing sunlight to form disc images of the sun on a single tower-mounted receiver, the heliostats are set close together in the field but spaced far enough apart to prevent collisions, to minimize shadowing of incoming sunlight by adjacent heliostats, and to minimize blocking of reflected light by adjacent heliostats. We show that such dense packing may be obtained by an embodiment of this invention which uses rectangular reflectors with spaceframe struts extending to each of their four corners.

Some embodiments of this invention overcome the limitations from complexity or stiffness, or both, of previous approaches which provided for shape change in heliostats. Thus in recent prior art, Angel et al demonstrated a prototype that focused solar disc images through the day, but at the cost of bending requiring three motor driven actuators and an electronic system for control and power. Some embodiments of the current invention are simpler and less expensive, requiring no added motors or control system.

In several embodiments of the current invention, the concave reflecting surface and its supporting frame are rectangular, with the sides of the rectangle oriented at 45degrees to the second, cross-axis of the target-oriented mount, as shown in FIGS. 4A-4C. Here the cross-axis is horizontal in the plane of the paper. FIG. 4A shows the spherical surface required for 0 degrees AOI, when the sun lies behind the receiver, in the direction of the target axis. FIGS. 4B and 4C show the contours of the surface to form a disc image of the sun for rotation of 60 and 70 degrees about the cross-axis, for sunlight angles of incidence of 60 and 70 degrees.

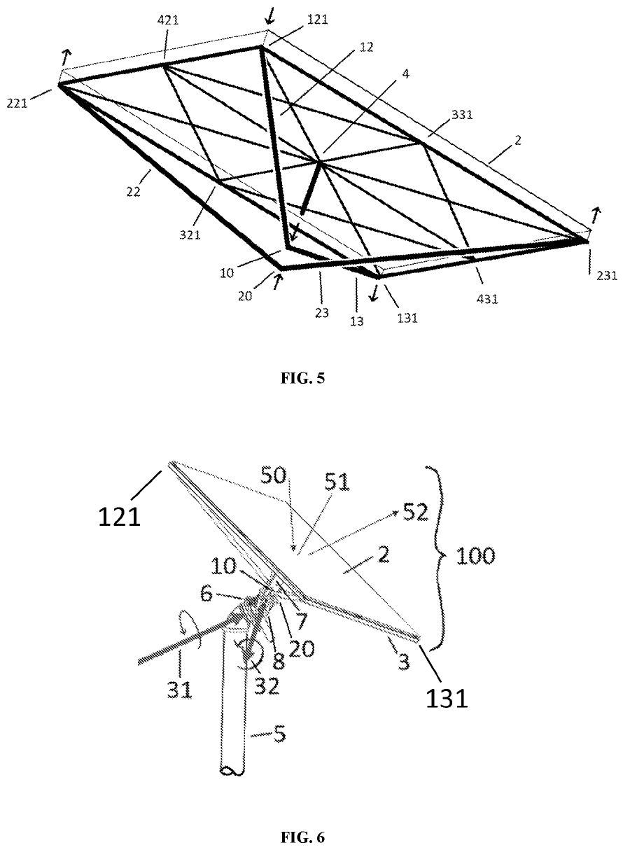

In an embodiment of this invention, these required changes in reflector and spaceframe shape are made using a reflector spaceframe support constructed as shown schematically in FIG. 5. A rectangular reflecting surface 2 is mounted on a planar rectangular frame 3 (see, FIG. 6), with corners 121, 231, 131 and 221, and with additional four out-of-plane back struts. The planar frame 3 comprises four perimeter struts forming the rectangle, connected by four diagonal radial struts to a central node 4, a further four radial struts from nodes 421, 331, 431 and 321, located in the middles of the rectangle sides, to node 4, and four shorter diagonal struts connecting the nodes 421, 331, 431 and 321 in the middles of the frame sides.

The two out-of-plane back struts 12 and 13 have first ends at the frame corners 121 and 131 and second ends at the back central node 10, and a further two out-of-plane back struts 22 and 23 that have first ends at the frame corners 221 and 231 and second ends at the node 20.

The shape of the spaceframe structure 100 and the attached reflector 2 is altered by extending or retracting the positions of the nodes 10 and 20 in the direction of the node 4, using mechanical links to the cross-axis motion, as described below. As indicated by the short arrows in FIG. 5, upward motion of node 20 causes struts 22 and 23 to push forward corners 221 and 231, while simultaneous downward motion of node 10 pulls back struts 12 and 13 and corners 121 and 131, twisting the frame 100 to induce the decreased tangential and increased sagittal curvatures shown in FIGS. 4A, 4B and 4C. In all other degrees of freedom, nodes 10 and 20 are constrained to act as a single node, connected by a single strut to node 4, thus preserving the integrity and stiffness of the spaceframe.

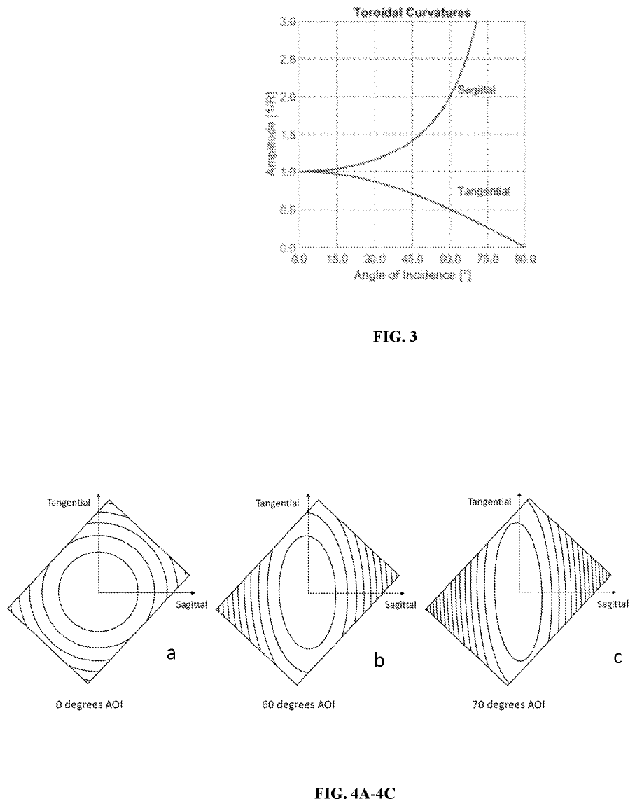

In some embodiments of the invention, the shape of the reflector when no forces are applied will be chosen to be that which minimizes the force magnitude (positive or negative) acting on nodes 10 and 20 when covering the full range of shape change. This shape will be the toroid for which the sagittal curvature change (as shown in FIG. 3) will be half that of the maximum sagittal curvature change desired. For example, if the desired maximum angle of incidence (AOI) is 70°, for which the curvature is three times that at 0°, the AOI will be set to be two times that at 0° AOI, i.e. 60 degrees.

Two different embodiments integrate the spaceframe of FIG. 5 with a target-oriented mount and provide the cam motions. These are:

1. Embodiment 1, in which the target and cross-axis drives are attached directly to each other in an integrated structure below the reflector spaceframe, and the cam system to move the neighboring nodes 10 and 20 employs curved slots through which drive-rollers are rotated directly by the cross-axis motion.

2. Embodiment 2, in which the target axis remains outside the spaceframe structure, separate from the cross-axis drive, which is located within the spaceframe, near node 4 and directly behind the reflector. The cam system is linear, using a rack and pinion driven by the cross-axis motor. Two struts that move parallel to the surface normal 51 carry the motions down to the nodes 10 and 20.

### Heliostat Embodiment 1

This embodiment is for a heliostat on a target-oriented mount, with the cross-axis motion mechanically linked to provide the required changes in toroidal shape. As shown in FIG. 6, the normal 51 to the reflector 2 is oriented such that incident sunlight rays 50 are reflected as rays 52 in the direction of the target, i.e. parallel to the target axis 31. The target axis bearing and drive 6 is located on a fixed vertical pedestal 5, and is part of an integrated dual axis assembly which includes a cross-axis drive and bearing 8 that turns the reflector about the perpendicular cross-axis 32. The spaceframe/reflector structure 100 is attached directly to the cross-axis drive 8 via the central back strut 7, which connects to the reflector central node 4. It is oriented as shown with the diagonal joining corners 121 and 131 approximately perpendicular to the cross axis 32.

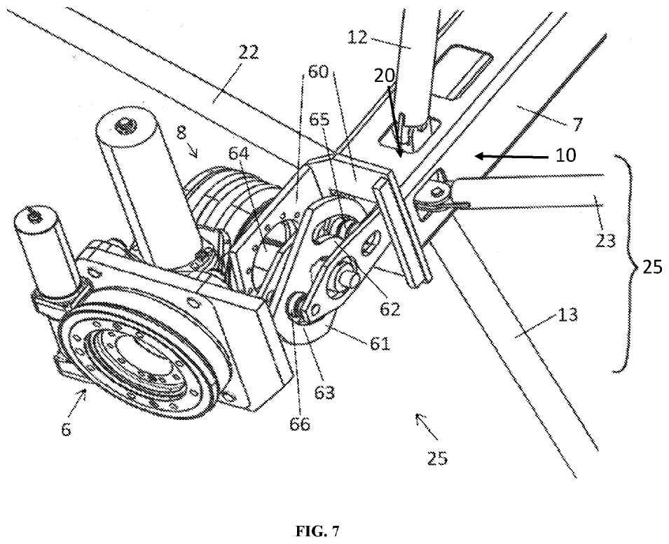

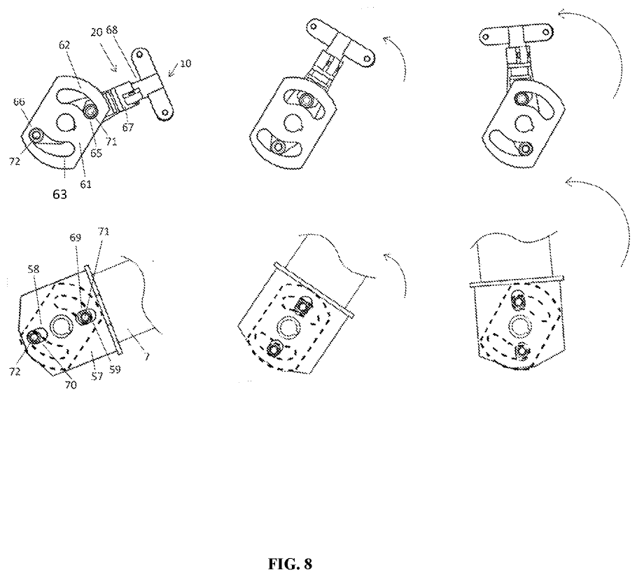

A mechanical linkage 25 to change the shape of the reflector 2 in synchronization with the cross-axis rotation is attached also to the cross-axis drive. Its operation is best understood with reference to the detailed drawing in FIGS. 7 and 8, in which some structures are not shown, in order to reveal key elements. An integrated dual axis drive comprises the target axis drive 6 and cross-axis drive 8, which turns the main central strut 7 of the reflector spaceframe support 100 via a stout L-shaped structure 60, (not all of which is shown). Within the structure 60 is a cam wheel 61 with two curved slots 62 and 63. The cam wheel 61 is attached rigidly via a shaft 64 to the rotating side of the target-axis bearing 6. Cross-axis rotation of the L structure 60 causes cam rollers 65 and 66 to be moved through the curved slots 62 and 63, moving them up or down in the direction of the support strut 7 and the reflector normal 51. This motion is communicated to the nodes 10 and 20 by two concentric tubes 67 and 68 shown in FIG. 8. The shapes of the two curved slots 62 and 63 are cut so that as the cross-axis is turned with respect to the cam wheel, with increasing angle of incidence, the nodes 20 and 10 are raised and lowered respectively. These slots are shaped such that the induced changes of toroidal reflector curvature are made non-linear with angle of incidence, as given by the Coddington equations. The slot shapes are pre-machined as needed, according to the size and shape of a given heliostat, and its required focal length, to obtain the changes in tangential and sagittal curvature shown in FIG. 3.

Motion of the cam rollers 65 and 66 relative to the nodes 10 and 20 in directions other than that of the normal 51 is prevented by additional rollers 69 and 70 on common shafts 71 and 72 attached in forks to the concentric drive cylinders 67 and constrained to move in straight slots in pairs of plates 57 attached to the L structure 60, on either side of the fixed cam wheel 61.

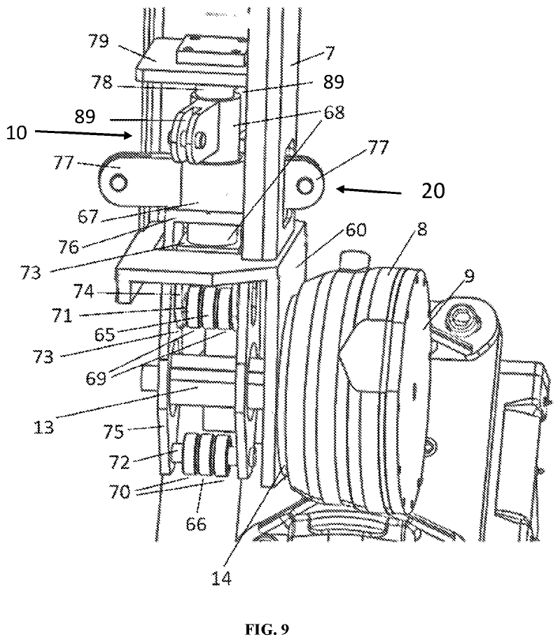

FIG. 9 shows in more detail how the function of the cross-axis bearing 8 to turn the cantilevered reflector spaceframe 100 is integrated with the mechanical coupling to move nodes 10 and 20 for shape change. The motions of the rollers 65 and 66 as they are rotated through the curved cam slots is communicated to the spaceframe nodes 10 and 20. As shown, the stationary face 9 of the bearing 8 is attached to the rotating side of the target axis bearing 6, while its rotating face 14 is attached via the L shaped link 60 to the main central strut 7, shown cut away to make clear the construction of the moving strut end connections 75 and 77, whose centers are the nodes 20 and 10.

The cam rollers 65 and 66 shown in FIGS. 7 and 8 are on shafts 71 and 72 that carry also pairs of rollers 69 and 70 to constrain lateral motion. To show more clearly how the rollers work, the plate 61 with the curved cam slots and the plates 57 with straight slots constraining rollers 69 and 70 are omitted from FIGS. 7 and 9. The shafts 71 and 72 communicate their vertical motions to the concentric drive tubes 67 and 68 via forks 74 and 75. The smaller, inner fork 74 carries the shaft 71 that holds the rollers in the upper curved slot 62, and has its top end connected to the bottom end of the inner tube 68. The top end of tube 68 fits within and is stabilized against lateral motion by shaft 78, which is connected by plate 79 to the central axial spaceframe strut 7. Similarly, the larger, outer fork 75 that carries the shaft 72 which holds the rollers in the lower curved slot 65 has its top end connected via plate 76 to the bottom end of the outer tube 67. The top end of tube 67 fits within and is stabilized against lateral motion by the inner tube 68. In this way, the motions of the links 89 and 77, and thus of the nodes 10 and 20, are constrained to be only in the direction perpendicular to the reflector frame and the central strut 7. All other degrees of freedom are rigidly fixed. Struts 7, 12, 23, 13 and 22 are held together at a single back node that preserves the integrity and stiffness of the spaceframe structure while allowing changes to its geometry and shape.

### Heliostat Embodiment 2

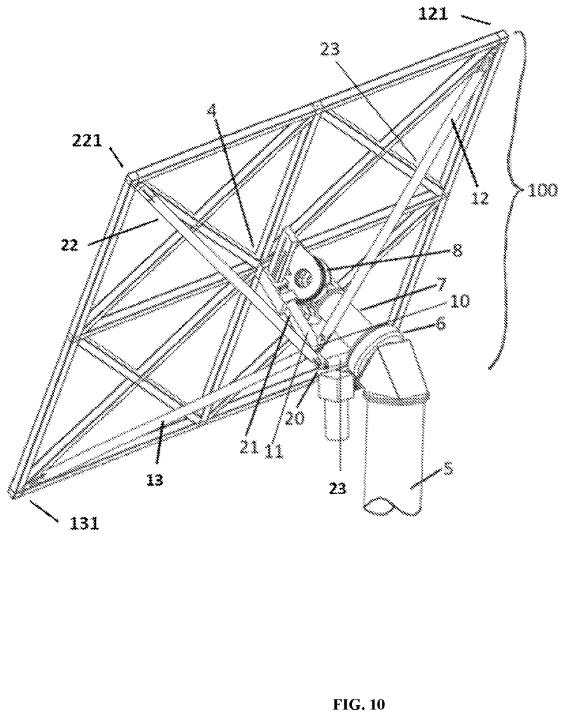

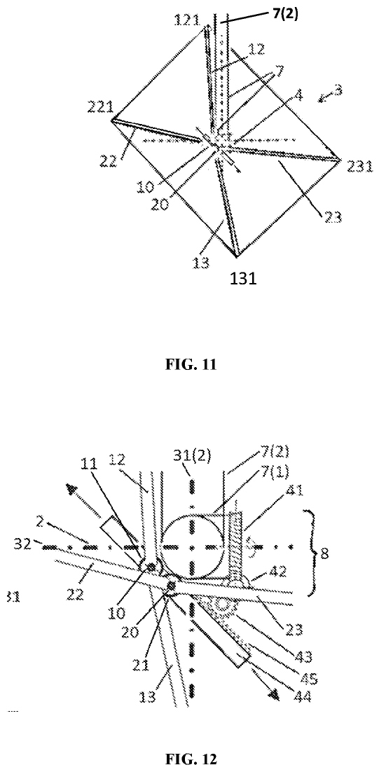

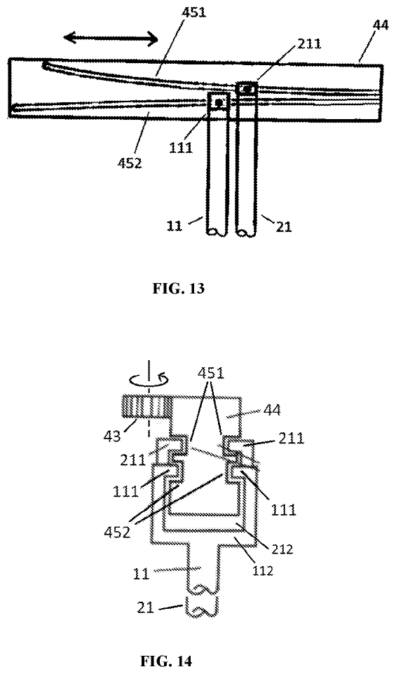

This embodiment is, as is the previous embodiment, for a heliostat on a target-oriented mount, with the cross-axis motion mechanically linked to provide the required changes in toroidal shape. But here, as shown in FIG. 10, the target-axis drive 6 is coupled to the spaceframe reflector support via a shaft 7 that reaches past the nodes 10 and 20 to the cross-axis drive 8, located near to the to the center node 4 of the reflector assembly 100. When the cross-axis drive 8 turns the reflector assembly, the central cantilevered strut 7 folds in between the back diagonal struts 12 and 23. The mechanical linkage coupled to the cross-axis drive now uses a rack and pinion mechanism with curved cam slots to produce the required motions for shape change, and these motions are transferred via struts 11 and 21 back to the nodes 10 and 20. FIGS. 11 and 12 are both drawn in the frame of reference of the spaceframe structure, viewed perpendicular to the reflector. The target axis shaft 7 is shown in two positions, at the two extremes of its 90° of rotation relative to the reflector frame 3, indicated as 7(1), (perpendicular to it) and 7(2), parallel to it. The drive 8 that turns the assembly 100 about the cross-axis 32 incorporates a worm gear 42 driving a worm wheel 41 turning about a shaft connected to the shaft 7. The shaft of the worm screw 42 drives also the linear motion of a rack 44, via a spur gear 43. The motion of the rack 44 is in the plane of the reflector frame 3, in a direction at 45 degrees to the cross axis 32. FIG. 13 shows a side view of the rack showing cam channels 451 and 452 curving up and down along the length of the rack. When the rack moves to the left or right, parallel to the reflector frame, rollers 211 and 111 in the channels move struts 11 and 21 perpendicular to the frame, in opposite directions, as needed to cause deformation of the reflector in synchronization with the cross-axis motion. The slot shapes are pre-machined as needed, according to the size and shape of a given heliostat, and of its required focal length, to obtain the changes in tangential and sagittal curvature shown in FIG. 3.

FIG. 14 shows an end view of the rack 44. The rollers 111 and 211 that fit into channels 451 and 452 are carried by forks 112 and 212 that straddling the rack 44. The base of these forks connect to the struts 11 and 12. held in their axial position by, cut in both sides of the rack 44.

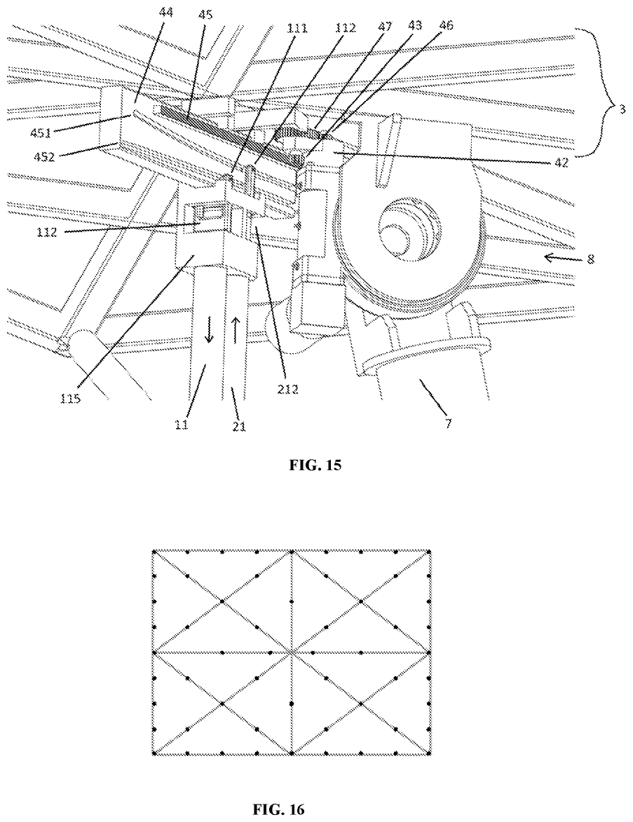

FIG. 15 is a three-dimensional view of the rack and pinion cam system showing details of the rack and pinion drive system and the axial strut coupling. drive strut coupling. The worm drive 42 that turns the cross-axis drive 8 turns also the pinion gear 43 via a spur gear 46 on the worm drive shaft, and a second spur gear 47 on the shaft of the pinion gear 43. The pinion gear 43 moves the rack 44 via the linear rack gear 45. The forks 112 and 212 that hold the rollers 111 and 112 in the channels 452 and 451 are constrained to move in only the axial direction by the bushing assembly 115, which is rigidly attached to the frame 3.

Finite Element Model of a Steel Spaceframe with Single Glass Sheet Reflector

In this embodiment of the invention, the reflector 2 is made from a single, flat, back-silvered sheet of low-iron float glass of specific dimensions. The accuracy of setting initial mid-range toroidal surfaces (for 60° angle of incidence) is explored for two different focal lengths. In addition, the accuracy is modeled over the range of toroidal shapes (for angles of incidence of 0 and 70 degrees) that can be obtained using an adjustable shape steel spaceframe. The spaceframe is of the type shown in FIG. 5, again with finite element modeling for specific dimensions.

The modeled rectangular reflector 2 attached to the front frame 3 measures 2.4 m×3.3 m, giving 8 m² in area, consistent with the largest size float glass sheets commonly available, conveniently shipped by container. The sheet is 3.2 mm thick and weighs 65 kg. We model the shaped reflectors for two cases: the shorter for slant range distance (focal length), the shortest envisaged, 64 m, and the longer of 130 m. The supporting steel frame was modeled with a spaceframe structure of struts as in FIGS. 5 and 16, the front frame of rectangular steel tubes with 2 in.×1 in.×⅛ in. wall thickness and the 4 back struts to the corners as 2″ diameter tubing, for a total weight of 120 kg. The connection between the glass sheet and the frame was modeled as using discrete support pads at the 59 positions shown in FIG. 16 and with positions adjusted to give a best fit to the ideal shape for 60° angle of incidence. The required upward and downward motions of the actuating struts 11 and 21 to move the corners up or down as shown were at most +16 mm for the shortest focal length considered, 64 m.

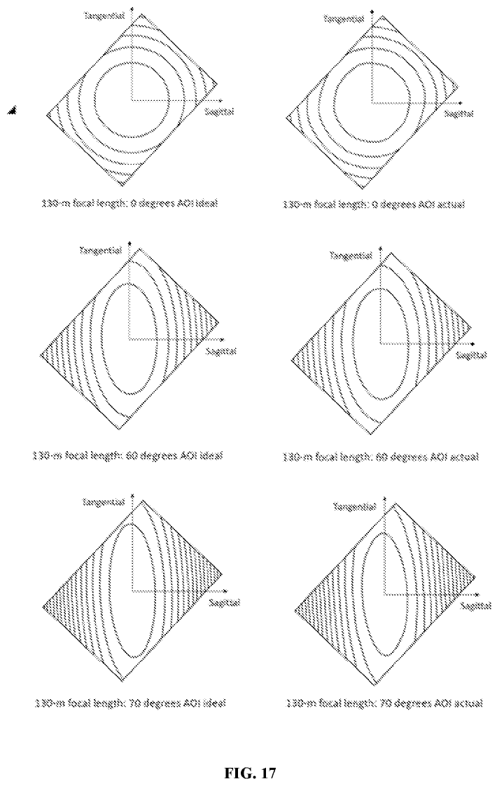

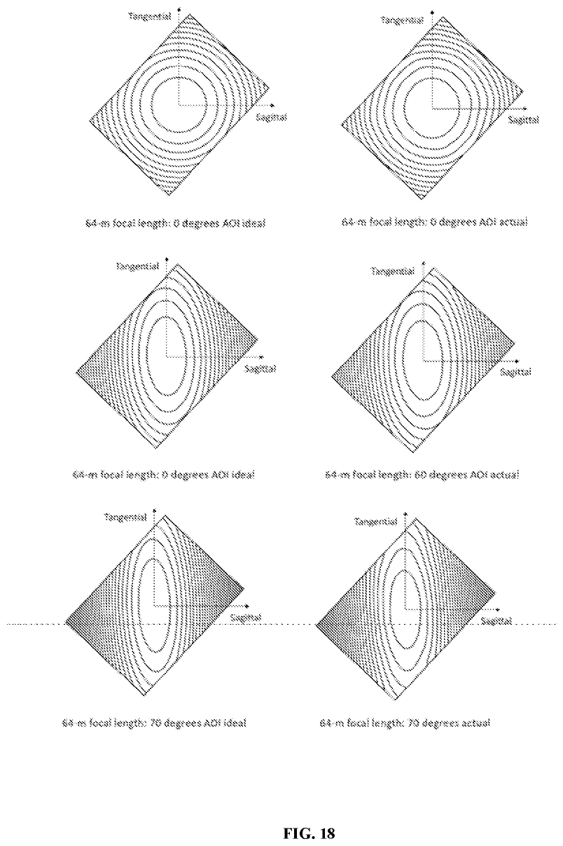

The capability of the dimensioned spaceframe reflector first to induce in the originally flat sheet of glass the base toroidal shape for 60° AOI, and then to change it over the range of angles of incidence from 0° to 70°, is shown in FIGS. 17 and 18. The orientation of the rectangle is shown turned at 45° to the sagittal (x) axis, which is aligned with the second, cross-axis of the target axis mount. The models are shown in FIG. 17 for focal lengths 130 m and in FIG. 18 for focal length 64 m, with surface contours drawn at 1.5 mm intervals. On the left are contours for the ideal shapes, and on the right contours of the induced shapes obtained from the models. The base 60° AOI shapes are shown in the center pair, and the top and bottom pair are for changed shapes. These are induced by motion of the 4 corner struts to obtain the required tangential flattening (reduction of curvature, 1/R) in the plane of incidence as the angle of incidence is increased, and the required accompanying increase in curvature in the transverse sagittal direction.

As can be seen, the contours of the induced shapes and their changes are close to the ideal. The base toroids for 60° AOI show errors relative to the ideal toroidal shapes, of 0.23 mrad rms for focal length 130 m and 0.44 mrad rms for 64 m. Then with the support frame actuated for 0° AOI, the errors are 0.35 and 0.71 mrad respectively. At the most extreme bending, for 70° AOI, they are 0.58 and 1.13 mrad respectively.

The model shows that the largest tensile stresses induced by the bending of the originally flat glass sheet can be as high as 1600 psi in small areas under the modeled support pads. In mass production, the bending forces will be applied by adhesive along the full length of the frame struts, for less localized and lower stresses. Effective stress over whole mirror area is ˜650 psi, a safe level.

In order to calculate the solar concentration that may be achieved in practice using heliostat with a reflector according to some embodiments of this invention, the broadening of the solar disc image it forms must be accounted for. This is done for a surface with given slope errors by calculating first the image that would be formed by rays reflected from a point source (such as a star). This image is then convolved with the known distribution of light across the disc of the sun.

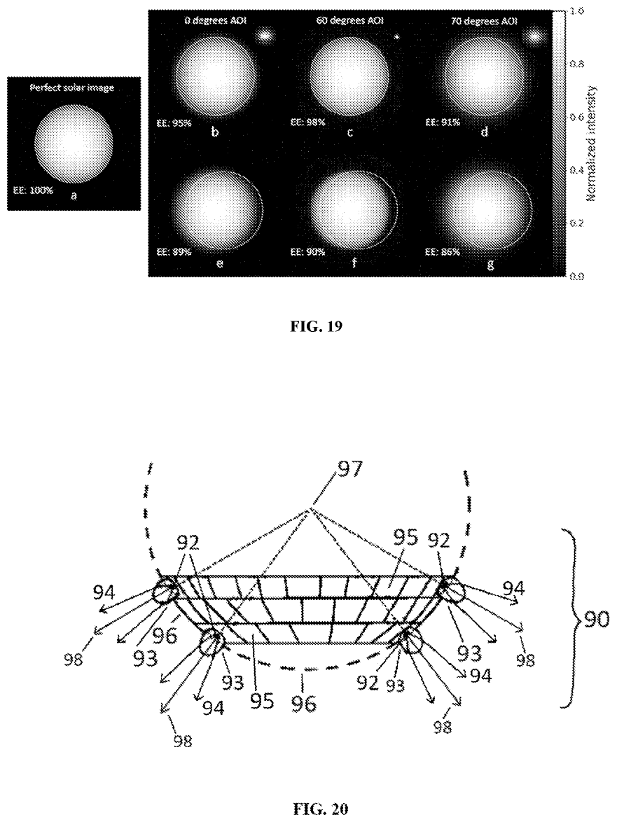

FIG. 19 (a) shows the intensity distribution across a perfectly formed disc image of the sun, including limb darkening, making it somewhat brighter in the center. The white circle is drawn at the full diameter (9.2 milliradians) where the intensity drops to zero. FIGS. 19 (b)-19 (d) show images of the sun and a star (shown to the upper right of the sun) modeled for a reflector of 130 m focal length with the surface errors modeled by finite element analysis, as given above. The solar images are obtained by convolving the ideal solar disc image with the point source broadening. For the point source star image in the worst case, at 70° AOI, the rms surface slope error in this is 0.5 mrad rms, and the calculated full width at half maximum (FWHM) is 1.4 milliradians, 17% that of the solar disc.

The result of the errors in reflector shape to cause spillage at the receiver is estimated for quantitatively the case in which the entrance to the receiver is circular, with diameter equal to that of the ideal solar disc image at the chosen focal distance. This diameter is shown by the white circles in all of FIGS. 19A-19G. In each case, the fraction of the full disc image lying within these apertures is marked on the figures as the percentage of encircled energy (EE). As shown in FIG. 19 (b), the EE for 0° AOI is 95%, in FIG. 19 (c), the EE for 60° AOI is 98%, and in FIG. 19 (d), the EE for 70° AOI is 91%, Such low spillage can be obtained only of the solar disc image is accurately centered on the circular receiver aperture. The effect of heliostat reflector misorientation is explored in FIGS. 19 (e)-19 (g), for the case of 0.5 milliradian of reflector mis-pointing, resulting in 1 milliradian of angular displacement of the disc images. As shown in FIG. 19 (e), the EE for 0° AOI is then reduced by 6% to 89%, in FIG. 19 (c), the EE for 60° AOI is reduced by 8% to 90%, in FIG. 19 (d), the EE for 70° AOI is reduced by 5% to 86%. It follows that to hold mis-pointing losses under the above assumptions to <8%, reflector pointing error should be kept to <0.5 milliradians.

### Closed Loop Heliostat Tracking Using a Fisheye Camera and an LED Light Source

In an embodiment of this invention with closed loop tracking to maintain accurate orientation of a field of heliostats, each heliostat reflector is equipped to measure its orientation using a rigidly attached camera with a fisheye lens. The camera records images including the sun and one or more tower-mounted light sources. The sources are located within or adjacent to the heliostat field, positioned so that each heliostat sees at least one light source at all times, in addition to the sun. Any error in orientation is computed from images showing both sources and used to make pointing correction.

FIG. 20 shows schematically an embodiment of an LED light source 90, in which multiple emitter assemblies comprise individual LEDs 92 with collimating lenses 93 that emit narrow cones of light 94. These assemblies are arranged on facets 95 tangent to a spherical, mounting surface 96. The assemblies shine out beams in directions centered on radial lines 98 from the center of the sphere 97.

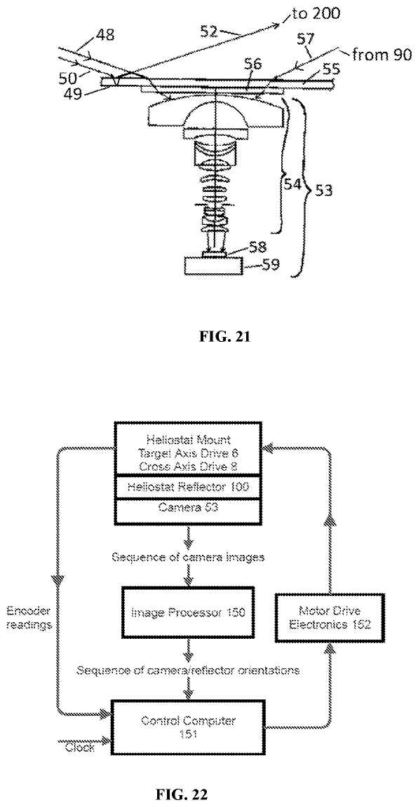

FIG. 21 shows a camera 53 with a fisheye lens 54, rigidly attached to each heliostat reflector assembly 100. In this embodiment the camera is located behind the glass sheet 55 of the reflector 2. Most rays of sunlight 50, those incident in regions of the reflector 2 away from the camera, are reflected from the silvered back surface 49 as rays 52, toward the distant receiver 200. Rays of sunlight 48 incident on a central region of the reflector pass through the glass 55, where the silvering 49 is removed, and are transmitted through a glass filter 56 and into the fisheye lens 54 of the camera 53 below, which includes a detector array 58 and readout electronics 59. The camera 53 is rigidly attached so as to be in fixed position relative to the glass reflector. The camera is illuminated also by the distant LED source 90, as illustrated by the ray 57.

FIG. 22 illustrates the operation of closed-loop tracking of the heliostat. Each camera 53, rigidly attached with known relative orientation to the reflector assembly 100, records images repeatedly, each image capturing the sun and at least one of the light sources 90. An image processor 150 associated with each camera uses this data, and the known position of the sun at the instant of imaging, to compute the orientation of the camera and heliostat reflector. A tracking control computer 151 uses the known positions of the light sources, and of the sun at the time of each exposure, to compute what the heliostat orientation should have been at that instant in order to accurately position the reflected sunlight at the receiver. By controlling the target and cross-axis heliostat drives through the drive electronics 152, the computer 151 adjusts the heliostat orientation and tracking rates as necessary to correct future orientation and tracking. This cycle of measurement and adjustment is repeated as often as needed to maintain accurate orientation throughout the day. Both the target and cross-axis motions will be equipped with low-cost encoders of moderate accuracy, sufficient to position the heliostat orientation prior to closed loop tracking.

The light sources 90 of this invention are made bright enough relative to the sun so that a single camera exposure short enough to capture a non-saturated solar disc image will also record a source image with good signal to noise ratio, and resolved over several camera image pixels, so that its centroid may be computed to sub-pixel level. The relative brightness of the sources to the sun is increased by a factor of 10 or more compared to a source with the same emission spectrum as the sun, such as reflected sunlight, by use of LEDs 92 that emit light in a narrow spectral range and using a narrow band filter 56 that transmits light only in the same narrow spectral range as the LED.

In an embodiment, the glass filter is Hoya type U340A that absorbs visible light except for a 40 nm wide band centered at 720 nm wavelength. The LED is chosen to have matching wavelength and spectral width. In a further step to obtain maximum brightness, the LEDs may be operated at higher-than-normal power in pulsed mode with low duty cycle, with a short camera exposure synchronized with the emission pulse.

The camera 53 may view the sun through the thin reflective silver film deposited on the back of the glass 55, which remains a continuous sheet, with no aperture cut through it. The usual protective copper and paint layers will in this case be removed, or not deposited in the first place. The transmission of the 100 nm thick silver film is in the range 0.1-1% for visible light, sufficient for the camera to image the sun. Alternatively, the silver may be removed from the camera viewing region, and a neutral density filter be used in addition to the glass filter 56.

Solar Concentrator of High Power and High Concentration with Heliostats Forming Solar Disc Images at the Entrances of CPCs

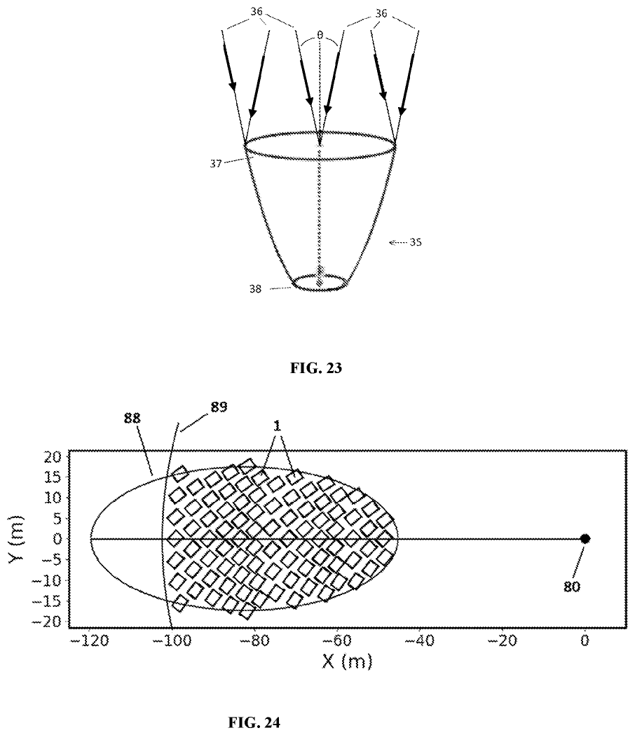

In this embodiment of the invention, sunlight from heliostats that reflect sunlight to form disc images of the sun is further concentrated by use of a compound parabolic concentrator (CPC) as illustrated in FIG. 23. A CPC 35 has the property that light rays 36 entering the circular entrance aperture 37 within a specific full cone angle θ are reflected down to an exit aperture 38 with a concentration increased by a factor that approaches 1/sin² (θ/2), depending on the CPC length.

In some embodiments of this invention, one or a multiplicity of CPCs powering a reactor receiver are set atop a tower and are aimed toward heliostats located on the ground within the elliptical section of the CPC cone. FIG. 24 shows a plan view of an example embodiment in which 89 heliostats 1 are located within one elliptical boundary 88 on flat ground seen by a CPC on a tower 80 with 23-degree full cone angle θ. The reflector shapes of these heliostats are changed through the day so that sunlight they reflect is focused to form a disc image of the sun. The heliostats are positioned in close proximity, but not so close as to hit each other, and out to the distance 89 from the CPC at which the solar disc image they form has a diameter that approximately equals that of the CPC entrance 70.

As a specific quantitative example, an analysis of the efficiency of delivery of concentrated sunlight is made here for the case of heliostats of the size analyzed above, each using a single 8.05 m² glass sheet. The CPC, with entrance cone of 23 degrees and entrance diameter 70 equal to 1 m, is placed on a 40 m high tower and aimed down at 30° below horizontal. Heliostats are located at radial distance 89 no larger than 100 m, for a maximum slant range (and heliostat focal length) of 108 m. At this distance, a perfectly formed disc image of the sun (9.2 mrad diameter) is 0.99 m, matched to the CPC entrance aperture 70.

The efficiency of delivery of sunlight to the receiver depends in part on geometric losses incurred by: shadowing by neighbor heliostats; reduction of the projected mirror area in proportion to the cosine of the angle of incidence; and blocking of the reflected light by neighbors. To estimate these losses, a 3-dimensional geometric model of the field was made, and views such as those shown in FIGS. 25A-25D were made for a range of solar elevations and azimuth angles. FIGS. 25A-25D show as an example the field of FIG. 24 with the heliostats oriented to reflect sunlight to the tower with the sun at elevation 40° and at two azimuth angles, 90° and 0° relative to the ground direction from the CPC center to the center of the ellipse 88. FIGS. 25A and 25C show the field as seen from the sun for azimuth angles 90° and 0° respectively. The heliostat reflectors are shown as transparent, shadowing loss is quantified as the fraction of projected reflector area where there is overlap. FIGS. 25B and 25D show the field seen from the receiver, for the same two solar azimuths, where now blocking is apparent as regions of overlap.

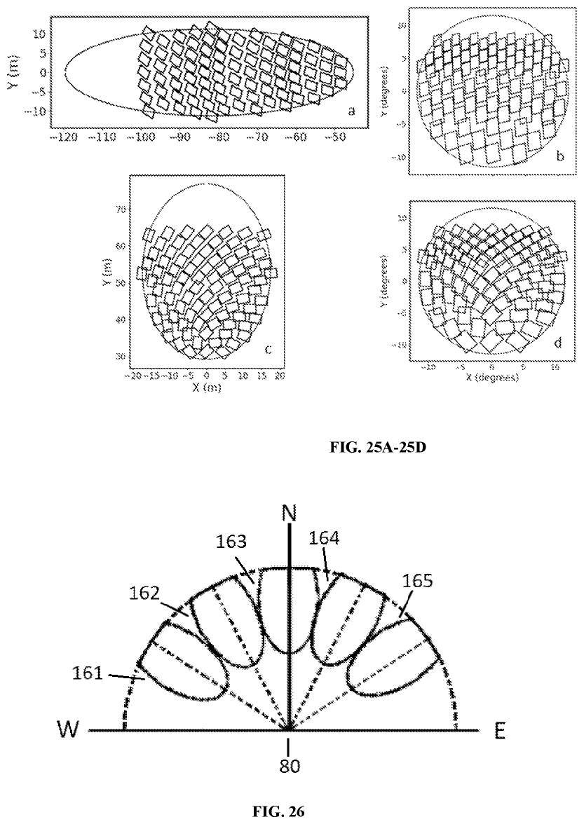

A practical embodiment of this invention will use not just one such elliptical field of heliostats powering one CPC on a tower, but a number of CPCs on a single tower, oriented to face out in different directions to view adjacent elliptical fields. FIG. 26 illustrates a configuration with five elliptical field units, 161, 162, 163, 164, and 165, each with 89 heliostats of the dimensions given in the example above. The fields and the five CPCs (not shown in FIG. 26) atop a tower 80 are oriented at azimuthal intervals of 28.5°. The total mirror area feeding the 5 CPCs is 3,520 m².

The geometric shadowing, cosine loss and blocking losses depend on latitude and time of day and year. Table 1 gives the area of sunlight reflected to each CPC, with the above geometric losses taken into account. The calculation is for this embodiment at a specific latitude, 32°, and a specific representative day, namely the equinox. The hour (relative to solar noon) is given in column 1, while the remaining columns give the area of sunlight receiver by each CPC, starting with CPC 1 powered by field 161 in FIG. 26., It will be seen that the differences in geometric loss between the different CPCs are not large, and thus an efficient system can be made with all CPCs powering a single reactor. The last column in Table 1 gives the total sunlight area delivered to such a reactor.

TABLE 1
Effective area of a field powering five CPCs

| | CPC 1 | CPC 2 | CPC 3 | CPC 4 | CPC 5 | Total |
|---|---|---|---|---|---|---|
| Time | Effective mirror area (m²) | | | | | |
| 6 | 0 | 0 | 0 | 0 | 0 | 0 |
| 7 | 420 | 361 | 346 | 331 | 288 | 1747 |
| 8 | 594 | 554 | 526 | 490 | 430 | 2593 |
| 9 | 596 | 617 | 615 | 564 | 480 | 2872 |
| 10 | 572 | 586 | 632 | 606 | 521 | 2916 |
| 11 | 613 | 578 | 609 | 628 | 578 | 3005 |
| 12 | 624 | 621 | 599 | 621 | 624 | 3089 |
| 1 | 578 | 628 | 609 | 578 | 613 | 3005 |
| 2 | 521 | 606 | 632 | 586 | 572 | 2816 |
| 3 | 480 | 564 | 615 | 617 | 596 | 2872 |
| 4 | 430 | 490 | 526 | 554 | 584 | 2593 |
| 5 | 288 | 331 | 346 | 361 | 420 | 1747 |
| 6 | 0 | 0 | 0 | 0 | 0 | 0 |

To estimate the power delivered to such a reactor, losses other than geometric are included. The reflectivity of the heliostat and CPC mirrors are both taken to be 90%. The spillage loss at the CPC entrance apertures, averaged over heliostats at all radii, is taken to be 10%, which includes the effect of both disc image blurring and heliostat orientation errors, based on the analysis in paragraph 77 above. Losses at the CPC vacuum windows are taken to be also 10%. On this basis, the effective area of sunlight delivered into the reactor will be reduced by a factor 0.66. The concentration at the entrance to the 5 CPCs, with total area 3.93 m², thus averages 516 suns at noon, and remains above 433 suns over 8 hours, from 8 am until 4 pm. With these estimates, and assuming a minimum direct solar flux at normal incidence of 700W/m² at 8 am and 4 pm, when the solar elevation is 25 degrees, the power delivered will remain above 1.3 MW for eight hours.

Given CPCs designed for 10 times concentration, i.e. with exit apertures of 316 mm diameter, the concentration of sunlight entering the reactor will remain above 4,330 suns for the 8-hour interval. This exceeds the >3,500 suns target projected for hydrogen generation by the cerium oxide redox reaction (Brendelberger reference). Thus, efficient thermal production of hydrogen should be possible.

High power solar concentrator with disc-imaging heliostats in a circular field, for high concentration at a central cylindrical receiver. (From provisional application)

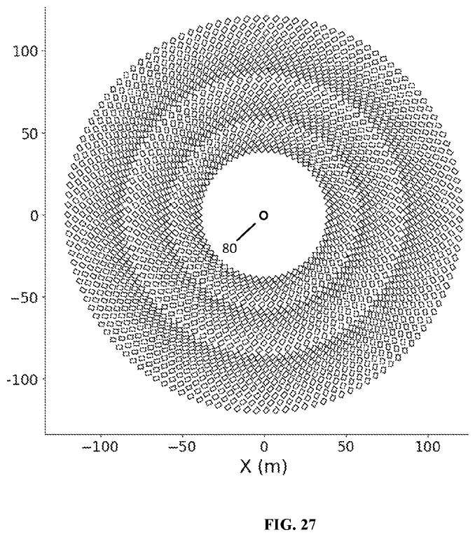

The potential for the heliostats according to some embodiments of this invention to obtain very high concentration when implemented in a concentrating solar power array is further illustrated in this embodiment, in which a circular field of disc-imaging heliostats is set about a central cylindrical receiver. FIG. 27 shows a plan view of the field, with a total of 2,064 rectangular heliostats. Each one has a single-piece, back-silvered rectangular glass reflector 2 measuring 3.3 m×2.44 m, the dimensions analyzed above. With each mirror having an area of 8.05 m², the total reflector area is 16,620 m². The heliostats, in 21 rings. extend from an inner radius of 40 m to an outer radius of 120 m, a total circular land area of 45,240 m². Considering the toroidal reflector shapes and shape changes required for the heliostats in this example field, the most steeply curved reflectors will be those on the inner diameter at distance 40 m from the receiver tower, which must focus on the receiver atop the 50 m high tower—a slant range distance of 64 m. For normal incidence reflection, the radius of curvature R=2F is thus 128 m.

Taking the heliostats to be oriented to reflect sunlight to a central cylindrical receiver at 50 m elevation, FIG. 27(a) shows views of a 45° segment of the field at azimuth 90 degrees as seen from the sun, and FIG. 27(b) the same segment as seen by a camera located at the receiver. The views are for solar elevation angle 40°. As can be seen from the receiver camera view, for the chosen layout and solar position there is little blocking of the reflected sunlight by neighboring heliostats. Similar calculations for other solar elevations and all azimuths give the effective mirror collection area by solar elevation angle, accounting for the area reduction as the cosine of the angle of incidence. These are 12,342 m² at 20° solar elevation, 13,376 m² at 40°, and 14,078 m² at 60°.

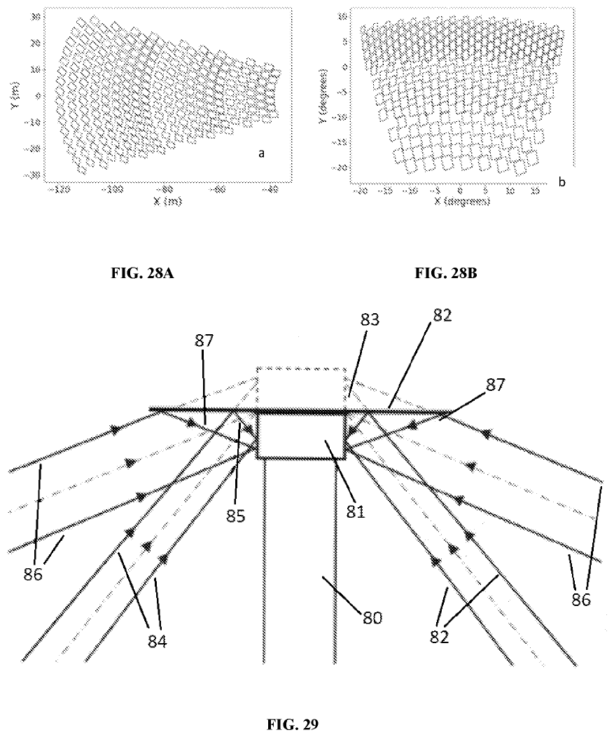

The ideally focused disc images, from the outer heliostats at 130 m slant range, are 1.20 m in diameter. The cylindrical receiver is sized with height and diameter of 1.4 m, with a surface area of 6.2 m². This is sufficient to reduce spillage such that over 90% of the reflected light averaged over the full field is received. With spillage loss from imperfect disc imaging thus at 10%, and heliostat reflectivity at 90%, the average concentration of sunlight for solar elevations of 60 degrees and 40 degrees will be 1,840× and 1,750× respectively. At a solar elevation of 20 degrees, the total area of sunlight available to the annular field is 13,750 m². Analysis similar to that of FIGS. 28A-28B shows that with spillage and reflectivity losses included, the concentration at the receiver is reduced to 1,000 suns.

Through the day, while the sun is over 20° elevation, this concentrating field will maintain a concentration at over 1000 suns. The delivered power, including the losses from spillage and reflectivity, referenced to a solar DNI flux of 1000 W/m², will range up to 11.4 MW for 60° elevation.

An embodiment of this invention further increases the concentration at a cylindrical receiver. A novel and simple flat circular reflector “beams down” the half of the light that, for a conventional cylindrical receiver, would illuminate the upper half of the cylinder. The height of the cylinder is then halved and the flux, now all on what was the lower half is doubled, as is the concentration.

FIG. 29 shows the half-height cylindrical receiver 81 atop a tower 80. A circular secondary reflector 82 is set level with the top of the receiving surface. Seen from any of the heliostats in the field, the receiver appears with its reflection 83 above as double its actual height. The rays 86 from the outer perimeter heliostats of the field and forming the largest disc images at the receiver are split, their top half being reflected by the disc 82 as rays 87 down to the receiver cylinder 81. Rays 84 from closer in heliostats forming smaller disc images but at steeper angle of incidence are split in the same way, their top halves reflected down as rays 85.

While various embodiments of the present invention have been described above, it should be understood that they have been presented by way of example only, and not limitation. Thus, the breadth and scope of the present invention should not be limited by any of the above-described illustrative embodiments, but should instead be defined only in accordance with the following claims and their equivalents.

The embodiments illustrated and discussed in this specification are intended only to teach those skilled in the art how to make and use the invention. In describing embodiments of the disclosure, specific terminology is employed for the sake of clarity. However, the disclosure is not intended to be limited to the specific terminology so selected. The above-described embodiments of the disclosure may be modified or varied, without departing from the invention, as appreciated by those skilled in the art in light of the above teachings. It is therefore to be understood that, within the scope of the claims and their equivalents, the invention may be practiced otherwise than as specifically described. For example, it is to be understood that the present disclosure contemplates that, to the extent possible, one or more features of any embodiment can be combined with one or more features of any other embodiment.

1. A heliostat, comprising:
a reflector comprising at least one segment arranged in a segment assembly and defining a reflecting surface;
a rigid spaceframe structure comprising a plurality of struts joined at nodes, said plurality of struts supporting said segment assembly so as to hold said reflecting surface in a concave toroidal shape;
a dual-axis mount constructed and arranged to support and orient said rigid spaceframe structure and said segment assembly so as to reflect sunlight incident on said reflecting surface toward a distant receiving surface, said dual-axis mount comprising at least two drives;
at least one mechanical linkage coupled to at least one drive of said dual-axis mount and configured to change a relative position of at least two nodes of said rigid spaceframe structure in synchronization with motion of said at least one drive, and thereby changing a shape of said rigid spaceframe structure and said reflector; and
wherein said change of said relative position of said at least two nodes alters said shape of said reflector in such a way as to change a toroidal reflector shape so as to form and maintain a focused disc image of the sun on said distant receiver as said dual-axis mount is turned to follow the sun's motion throughout the day.

2. The heliostat of claim 1, wherein each segment of said at least one segment of said reflector comprises a back-silvered glass mirror.

3. The heliostat of claim 1, wherein said rigid spaceframe structure comprises:
a planar front frame to which said reflector is attached;
a plurality of back drive struts each having first ends at points on a perimeter of said front frame and second ends at central back nodes such that positions thereof are adjustable relative to said front frame,
wherein said rigid spaceframe structure provides rigidity and an adjustable toroidal shape to said reflector.

4. The heliostat of claim 3, wherein said dual-axis mount is a target-oriented type in which a target-axis drive rotates said heliostat reflector about the target axis, which is directed toward a distant solar receiver, in the direction of the reflected sunlight, and a cross axis drive that rotates said reflector about a cross-axis that is perpendicular to both said target axis and said reflector; and
wherein said dual-axis mount has a rotation angle equal to an angle of incidence of incident sunlight.

5. The heliostat of claim 4, wherein said at least one mechanical linkage is located near, and is coupled to a cross axis rotation drive and is configured so as to extend or retract said second end of at least one of said plurality of back drive struts in synchronization with a rotation about said cross axis and said angle of incidence of the sunlight.

6. The heliostat of claim 1, further comprising a control computer configured to communicate with said dual-axis mount,
wherein said at least two drives of said dual-axis mount comprises two motorized slew drives, and
wherein dual axes of said dual-axis mount are rotated by said motorized slew drives in response to said control computer.

7. The heliostat of claim 4, wherein said reflecting surface is a rectangular and a concave reflecting surface,
wherein said front frame is rectangular and the sides thereof are mounted at 45 degrees to said cross axis, and
wherein as said cross-axis and angle of incidence are increased, said coupled mechanical linkage moves a first back node in a direction either toward or away from the center of said reflector, this node being a connected to the first ends of two back struts whose second ends are attached to two opposite corners of said front frame, thereby raising or lowering them, while at the same time said linkage moves a second back node in the opposite direction relative to said reflector center, this node being a connected to the first ends of two additional back struts whose second ends are attached to the other two opposite corners of said rectangular front frame, thereby moving them in the opposite direction;
and wherein said front frame is thereby twisted, to a degree dependent on the angle of incidence.

8. The heliostat of claim 7 in which said mechanical linkage to the cross axis rotation is configured with cams such that the curvature, along the said diagonal more closely aligned with the cross axis, increases with increasing angle of incidence, with the dependence required for the sagittal direction of a focusing toroidal surface, while the curvature along the diagonal more closely perpendicular to the cross-axis decreases with angle of incidence, with the dependence required for the tangential direction of a focusing toroidal surface;
and wherein the overall toroidal reflector shape is changed as needed to focus disc images of the sun over a wide range of angles of incidence.

9. The heliostat according to claim 7, wherein said concave reflecting surface is set, when no bending forces applied by the two back active nodes, to a toroidal shape required for an intermediate angle of incidence, chosen so as to minimize the highest force, positive or negative, needed to be applied at said center nodes to cover the full range of node motions and toroidal shapes needed to form solar disc images, from the smallest to the largest required angle of incidence.

10. The heliostat according to claim 1, wherein both drives of said dual axis mount are in an integrated unit, mounted on a support pedestal, and orienting said spaceframe assembly from a rear attachment, and in which said mechanical linkage comprises:
a cam wheel defining two curved slots therein, said cam wheel being turned by a shaft connected to a target-axis side of said cross-axis bearing;
wherein said adjustable nodes connect to and are moved by two-pronged forks with shafts that carry drive rollers that fit into said curved slots;
wherein additional rollers on said shafts are constrained to move in straight slots perpendicular to the frame, in order to prevent said curved slot drive rollers from moving laterally in the plane of the reflector frame;
wherein motions of said adjustable nodes are additionally constrained by bushings to move only on a common axis perpendicular to the reflector;
and wherein as said cam wheel is turned with said cross axis rotation, said adjustable position nodes are extended or retracted in the direction perpendicular to said reflector frame, by distances determines by the different shapes of said two cam slots.

11. The heliostat according to claim 1, wherein said dual axis mount comprises separated target and cross-axis drives, said target axis drive being outside said spaceframe, and linked by said shaft reaching through said spaceframe assembly to said cross-axis drive, located near the center of said front planar frame; and wherein said mechanical linkage comprises:
a pinion-driven rack with said pinion geared to the motor that drives the cross-axis rotation, and said rack moving in a direction parallel to said reflecting surface,
wherein said rack has two curved channels cut in either side, and the first ends of two back struts terminated in horseshoes with drive rollers that fit into said channels,
wherein said channels curve either up or down along the length of the rack, so that as the rack is driven along, said back strut first ends are moved perpendicular to the frame in opposite directions, wherein the second ends of said moved back struts connect to said adjustable nodes;
and wherein as said cam wheel is turned with said cross axis rotation, said adjustable position nodes are extended or retracted in the direction perpendicular to said reflector frame, by distances determines by the different shapes of said two cam slots.

12. A system for tracking a plurality of heliostats, comprising:
a plurality of heliostats arranged in a heliostat field;
a plurality of wide-field digital fisheye cameras, one attached rigidly to the reflector or support frame of each of said heliostats;
One or more light sources located on towers, within or adjacent to said heliostat field, with at least one of said light sources arranged to be visible to each of said plurality of wide-field digital fisheye cameras;
an image processor configured to communicate with each camera of said plurality of wide-field digital fisheye cameras to record image data for a continuous sequence of images, each image of said sequence of images capturing the sun and at least one said light source; and
a computer configured to receive said image data from said image processor,
wherein said computer is configured to process said image data, in conjunction with the known position of said light source and position of the sun at each instant of imaging, to compute an orientation of each heliostat reflector of said plurality of heliostats, and to control and correct future tracking motions of each heliostat so as to direct reflected sunlight accurately to a receiver of said plurality of heliostats.

13. The system of claim 12, wherein each camera of said plurality of wide-field digital fisheye cameras is centered within in or behind said heliostat reflector.

14. The system of claim 12, wherein said light source comprises a plurality of light emitting diodes that emit in a narrow wavelength band, and wherein each said camera of wide-field digital fisheye cameras comprises a filter having a narrow transmission band to transmit said emission from said plurality of light emitting diodes while rejecting more than 90% of the full spectrum of the sun.

15. A system for focusing sunlight at high power and concentration, comprising:
a tower;
one or a plurality of compound parabolic concentrators (CPCs) mounted atop said tower;
a plurality of heliostats arranged in an array on the ground, each heliostat of said plurality of heliostats comprising an active reflector, each said active reflector defining a reflector shape that is changed while in operation so that reflected sunlight is focused to form and maintain a disc image of the sun centered on one of said CPCs over a period of time while in operation,
wherein said plurality of heliostats are arranged within one or more ellipses formed by an intersection of an acceptance cone angle of each CPC and the ground, in a close packed configuration within each ellipse, out to distances not larger than that which yields a disc image of the sun equal in size to the CPC entrance diameter, and
wherein the sunlight from the plurality of heliostats is efficiently coupled into said CPC, which outputs high power solar energy at high concentration, up to 4,000 suns.

16. An apparatus for focusing sunlight at high power and concentration comprising:
a tower;
a cylindrical receiver mounted on said tower; and
a plurality of heliostats, each heliostat of said plurality of heliostats comprising an active reflector, each said active reflector defining a reflector shape that is changeable while in operation so that reflected sunlight is focused to form and maintain a disc image of the sun over a period of time while in operation,
wherein said plurality of heliostats are arranged in a 360-degree array surrounding said tower and oriented to reflect and focus said solar disc images onto said cylindrical receiver,
wherein said receiver presents an area to any one of said plurality of heliostats of no more than twice that of an accurately imaged solar disc from the distance of the most distant heliostat, and
wherein solar concentration averaging over the full cylinder surface of >1000 suns is achieved for solar elevations >20 degrees.

17. The apparatus according to claim 16, further comprises a flat mirrored disc arranged to reflect down an upper half of said disc images to said cylindrical receiver,
wherein said cylindrical receiver is half the height of said accurately imaged solar disc, and
wherein a surface area of said cylindrical receiver is halved and a concentration of light is doubled by said flat mirror.
